(19) United States
(12) Patent Application Publication
(10) Pub. No.: US 2026/0025576 A1
(43) Pub. Date: Jan. 22, 2026

(54) SYNCHRONIZATION METHOD OF IMAGE SENSOR AND SYNCHRONIZATION SYSTEM OF IMAGE SENSOR

(71) Applicant: REALTEK SEMICONDUCTOR CORPORATION, Hsinchu (TW)

(72) Inventors: YU-CHEN WANG, Suzhou (CN); JIAN SUN, Suzhou (CN); DONG-YU HE, Suzhou (CN)

(21) Appl. No.: 19/268,382

(22) Filed: Jul. 14, 2025

(30) Foreign Application Priority Data
Jul. 18, 2024 (CN) 202410968813.3

(51) Int. Cl. H04N 23/60; H04N 23/45

(52) U.S. Cl. CPC H04N 23/665; H04N 23/45

(57) ABSTRACT

A synchronization method of image sensors includes: obtaining a first current time of a first current frame of a first image sensor; obtaining a first previous time of a first previous frame and a second current time of a second current frame of a second image sensor; calculating a first difference between the first current time and the second current time; calculating a second difference between the first current time and the first previous time; and adjusting a line length or a frame length of the second image sensor according to a first determination result of the first difference and the second difference to synchronize the first image sensor and the second image sensor.

### BACKGROUND OF THE INVENTION

### 1. Field of the Invention

The present disclosure relates to a synchronization method of image sensors and a synchronization system of image sensors, especially to a synchronization method of image sensors and a synchronization system of image sensors that can synchronize multiple image sensors by adjusting line length or frame length.

### 2. Description of Related Art

With the progress of technology, more and more electronic products are equipped with multiple image sensors for users to take photos. However, since multiple image sensors operate independently, with different reference clocks, start times, and exposure processing, multiple data frames obtained by multiple image sensors cannot be synchronized. As a result, it is hard to ensure that multiple images can be correctly processed (e.g., image stitching), and the accuracy of Artificial Intelligence (AI) image recognition algorithms in processing multiple images cannot be guaranteed.

### SUMMARY OF THE INVENTION

In some aspects, an object of the present disclosure is to, but not limited to, provides a synchronization method of image sensors and a synchronization system of image sensors that make an improvement to the prior art.

An embodiment of a synchronization method of image sensors of the present disclosure includes: obtaining a first current time of a first current frame of a first image sensor; obtaining a first previous time of a first previous frame and a second current time of a second current frame of a second image sensor; calculating a first difference between the first current time and the second current time; calculating a second difference between the first current time and the first previous time; and adjusting a line length or a frame length of the second image sensor according to a first determination result of the first difference and the second difference to synchronize the first image sensor and the second image sensor.

An embodiment of a synchronization system of image sensors of the present disclosure includes a memory and a processor. The memory is configured to store a plurality of commands. The processor is configured to read the plurality of commands from the memory to execute following steps: obtaining a first current time of a first current frame of a first image sensor; obtaining a first previous time of a first previous frame and a second current time of a second current frame of a second image sensor; calculating a first difference between the first current time and the second current time; calculating a second difference between the first current time and the first previous time; and adjusting a line length or a frame length of the second image sensor according to a first determination result of the first difference and the second difference to synchronize the first image sensor and the second image sensor.

Technical features of some embodiments of the present disclosure make an improvement to the prior art. The synchronization method of image sensors and the synchronization system of image sensors of the present disclosure can synchronize multiple image sensors by adjusting line length or frame length to ensure that multiple images can be correctly processed (e.g., image stitching), and the accuracy of Artificial Intelligence (AI) image recognition algorithms in processing multiple images can be guaranteed.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a synchronization system of image sensors of the present disclosure.

FIG. 2 shows an embodiment of a flow diagram of a synchronization method of image sensors of the present disclosure.

FIG. 3 shows an embodiment of frame rate of multiple image sensors of the present disclosure.

FIG. 4 shows an embodiment of line length, vertical blanking, frame length, and horizontal blanking of the present disclosure.

FIG. 5 shows an embodiment of a flow diagram of a synchronization method of image sensors of the present disclosure.

FIG. 6 shows an embodiment of frame rate of multiple image sensors of the present disclosure.

### DETAILED DESCRIPTION OF THE PREFERRED EMBODIMENTS

To address the problem in the prior art that multiple images obtained by multiple image sensors cannot be synchronized, the present disclosure provides a synchronization method of image sensors and a synchronization system of image sensors, which will be explained in detail as shown below.

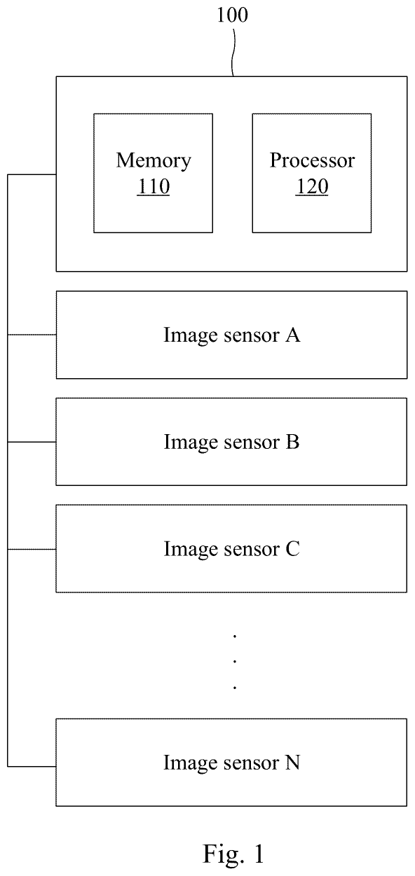

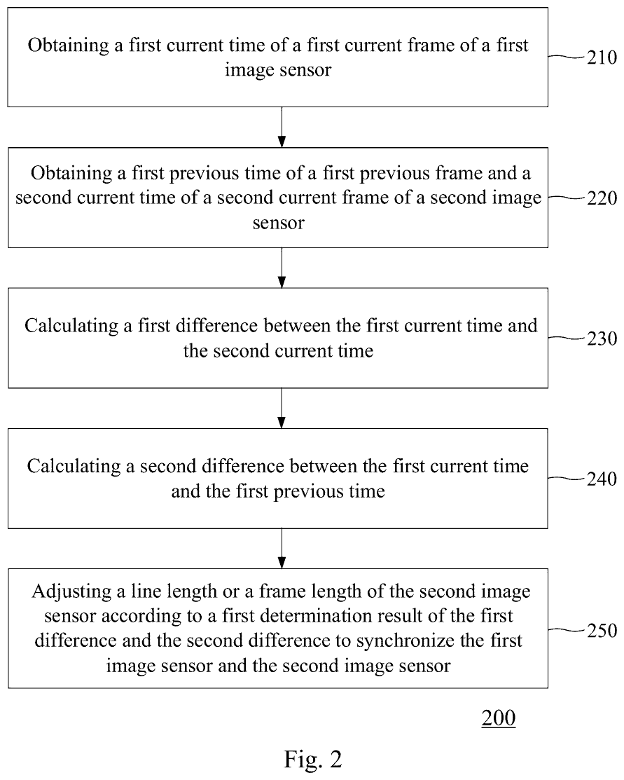

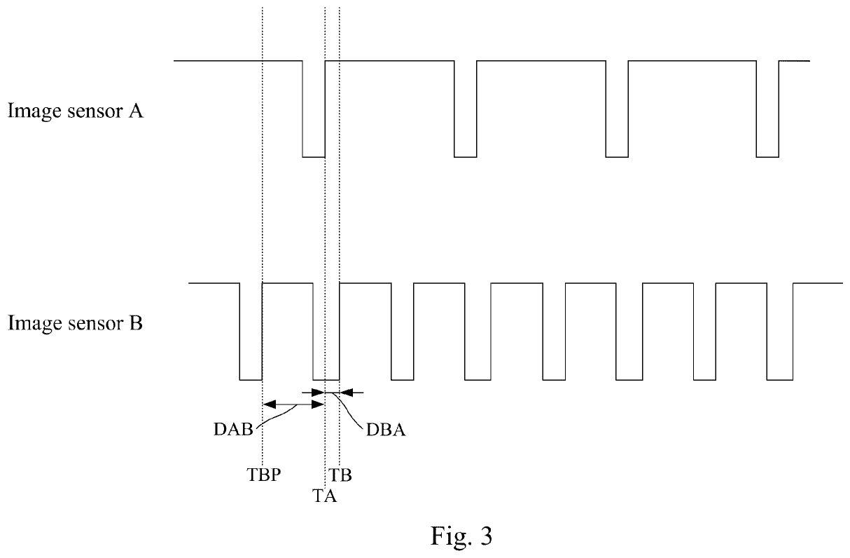

FIG. 1 shows an embodiment of a synchronization system 100 of image sensors of the present disclosure. As shown in the figure, the synchronization system 100 of image sensors includes a memory 110 and a processor 120. The memory 110 is configured to store a plurality of commands. The processor 120 is configured to read the plurality of commands from the memory 110 to execute corresponding operations. For facilitating the understanding of operations of the synchronization system 100 of image sensors, please refer to both FIG. 2 and FIG. 3. FIG. 2 shows an embodiment of a flow diagram of a synchronization method 200 of image sensors of the present disclosure, and FIG. 3 shows an embodiment of frame rate of multiple image sensors of the present disclosure.

Before executing the synchronization method 200 of image sensors, multiple image sensors (e.g., image sensors A˜N) can generate images respectively. Since multiple image sensors may not synchronized with each other, many problems arise. The synchronization method 200 of image sensors of the present disclosure can synchronize multiple image sensors, which will be explained in detail as shown below.

In step 210, obtaining a first current time of a first current frame of a first image sensor. For example, referring to FIG. 1 and FIG. 3, the processor 120 can be configured to obtain the current time TA of the current frame of the image sensor A.

In step 220, obtaining a first previous time of a first previous frame and a second current time of a second current frame of a second image sensor. For example, referring to FIG. 1 and FIG. 3, the processor 120 can be configured to obtain the previous time TBP of the previous frame and the current time TB of the current frame of the image sensor B.

In step 230, calculating a first difference between the first current time and the second current time. For example, referring to FIG. 1 and FIG. 3, the processor 120 can be configured to calculate the difference DBA between the current time TA and the current time TB. In some embodiments, the synchronization method 200 of image sensors of the present disclosure can subtract the first current time from the second current time to obtain the first difference. For example, referring to FIG. 1 and FIG. 3, the processor 120 can subtract the current time TA from the current time TB to obtain the difference DBA.

In step 240, calculating a second difference between the first current time and the first previous time. For example, referring to FIG. 1 and FIG. 3, the processor 120 can be configured to calculate the second difference DAB between the current time TA and the previous time TBP. In some embodiments, the synchronization method 200 of image sensors of the present disclosure can subtract the first previous time from the first current time to obtain the second difference. For example, referring to FIG. 1 and FIG. 3, the processor 120 can subtract the previous time TBP from the current time TA to obtain the difference DAB.

In step 250, adjusting a line length or a frame length of the second image sensor according to a first determination result of the first difference and the second difference to synchronize the first image sensor and the second image sensor. For example, referring to FIG. 1 and FIG. 3, the processor 120 can adjust the line length (e.g., horizontal total size, HTS) or the frame length (e.g., vertical total size, VTS) of the image sensor B according to a determination result of the difference DBA and the difference DAB to synchronize the image sensor A and the image sensor B.

As described above, the synchronization method 200 of image sensors and the synchronization system 100 of image sensors of the present disclosure can synchronize multiple image sensors by adjusting line length HTS or frame length VTS to ensure that multiple images can be correctly processed (e.g., image stitching), and the accuracy of Artificial Intelligence (AI) image recognition algorithms in processing multiple images can be guaranteed. It is noted that the line length HTS refers to the number of pixels in a column, and the frame length VTS refers to the number of columns in a frame. Additionally, the present disclosure utilizes the image sensor with the lowest frame rate as the reference. For example, if the frame rate of the image sensor A is lower than the frame rate of the image sensor B, the present disclosure utilizes the image sensor A as the reference.

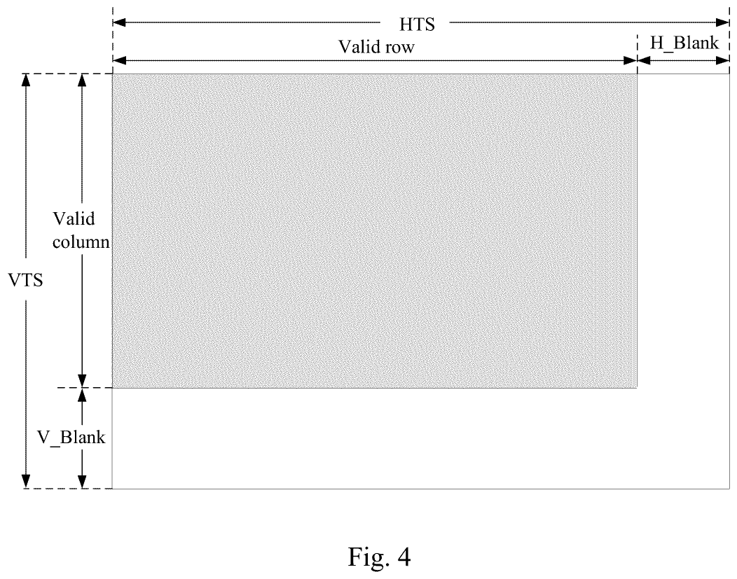

In some embodiments, the line length includes a horizontal blanking, and the frame length includes a vertical blanking. The synchronization method of image sensors can adjust the line length by adjusting the horizontal blanking of the second image sensor or adjust the frame length by adjusting the vertical blanking of the second image sensor. Reference is made to FIG. 4, for example, the line length HTS includes the horizontal blanking (e.g., H_Blank), and the frame length VTS includes the vertical blanking (e.g., V_Blank). The synchronization method 200 of image sensors can adjust the line length HTS by adjusting the horizontal blanking (e.g., H_Blank) of the image sensor B or adjust the frame length VTS by adjusting the vertical blanking (e.g., V_Blank) of the second image sensor B to synchronize the image sensor A and the image sensor B. For example, the present disclosure can increase value of H_Blank (horizontal blanking) and V_Blank (vertical blanking) to decrease the frame rate, and decrease value of H_Blank (horizontal blanking) and V_Blank (vertical blanking) to increase the frame rate. The present disclosure can adjust frame rate by adjusting value of H_Blank (horizontal blanking) and V_Blank (vertical blanking) to synchronize the image sensor A and the image sensor B. It is noted that, the line length HTS in FIG. 4 includes horizontal blanking (e.g., H_Blank) and valid row. The size of the horizontal blanking (e.g., H_Blank) can be 100, and the size of the valid row is 1920. Besides, the frame length VTS includes vertical blanking (e.g., V_Blank) and valid column. The size of the vertical blanking (e.g., V_Blank) can be 200, and the size of the valid column is 1080.

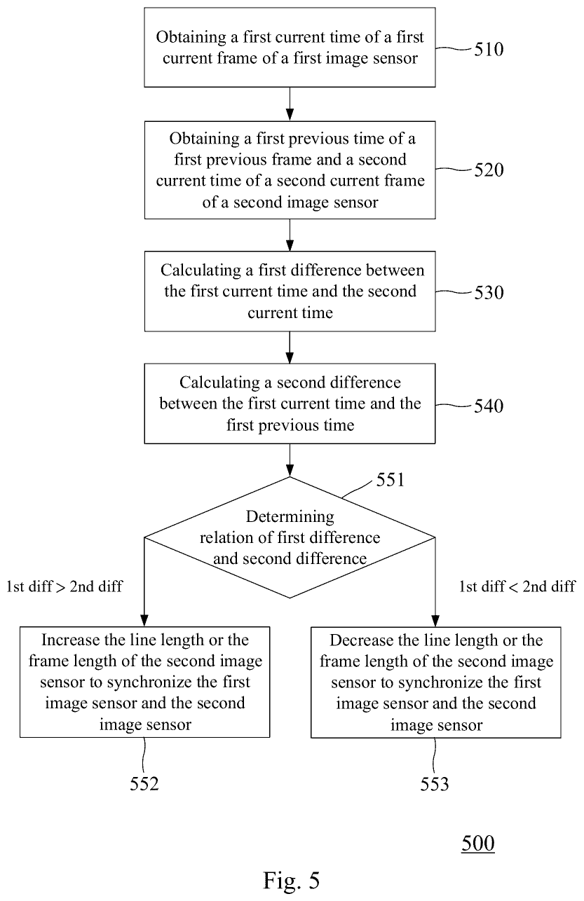

FIG. 5 shows an embodiment of a flow diagram of a synchronization method 500 of image sensors of the present disclosure. Compared to FIG. 2, the synchronization method 500 of image sensors in FIG. 5 is further illustrated as an example for the step 250 in FIG. 2, which will be explained in detail as shown below.

First of all, steps 510˜540 in FIG. 5 correspond to steps 210˜240 in FIG. 2. For the sake of brevity, details of steps 510˜540 will be omitted herein. In step 551, determining a relation of the first difference and the second difference. If it is determined that the first difference is larger than the second difference, step 552 is executed to increase the line length or the frame length of the second image sensor to synchronize the first image sensor and the second image sensor. For example, referring to FIG. 1 and FIG. 5, the processor 120 can determine a relation of the difference DBA and the difference DAB. If it is determined that the difference DBA is larger than the difference DAB, it represents that the frame rate of the image sensor B is faster relative to the frame rate of the image sensor A. The processor 120 increases the line length HTS or the frame length VTS of the image sensor B to decrease the frame rate of the image sensor B, so that the image sensor B can align frames with the image sensor A, thereby synchronizing the image sensor B and the image sensor A.

Besides, if it is determined that the first difference is less than the second difference in the step 551, the step 553 is executed to decrease the line length or the frame length of the second image sensor to synchronize the first image sensor and the second image sensor. For example, referring to FIG. 1 and FIG. 5, the processor 120 can determine a relation of the difference DBA and the difference DAB. If it is determined that the difference DBA is less than the difference DAB, it represents that the frame rate of the image sensor B is slower relative to the frame rate of the image sensor A. The processor 120 decreases the line length HTS or the frame length VTS of the image sensor B to increase the frame rate of the image sensor B, so that the image sensor B can align frames with the image sensor A, thereby synchronizing the image sensor B and the image sensor A.

In some embodiments, the first frame rate of the first image sensor is the same as the second frame rate of the second image sensor. For example, the frame rate of the image sensor A is the same as the frame rate of the image sensor B. For instance, the frame rates of the image sensor A and the image sensor B are all xFPS (frame per second), and x is a positive integer.

In some embodiments, the second frame rate of the second image sensor is N times the first frame rate of the first image sensor, wherein N is an integer larger than 2. For instance, the frame rate of the image sensor A can be xFPS, the frame rate of the image sensor B can be 2xFPS, and x is a positive integer. Alternatively, the frame rate of the image sensor B can be an integer multiple (e.g., twice, third times, etc) of the image sensor A. For instance, the frame rate of the image sensor B is 2xFPS, the frame rate of the image sensor A is xFPS, and x is a positive integer. Alternatively, the frame rate of the image sensor B is twice the frame rate of the image sensor A.

In some embodiments, the current time TA, the current time TB, and the previous time TBP can select the frame start time or the frame end time depending on the requirements.

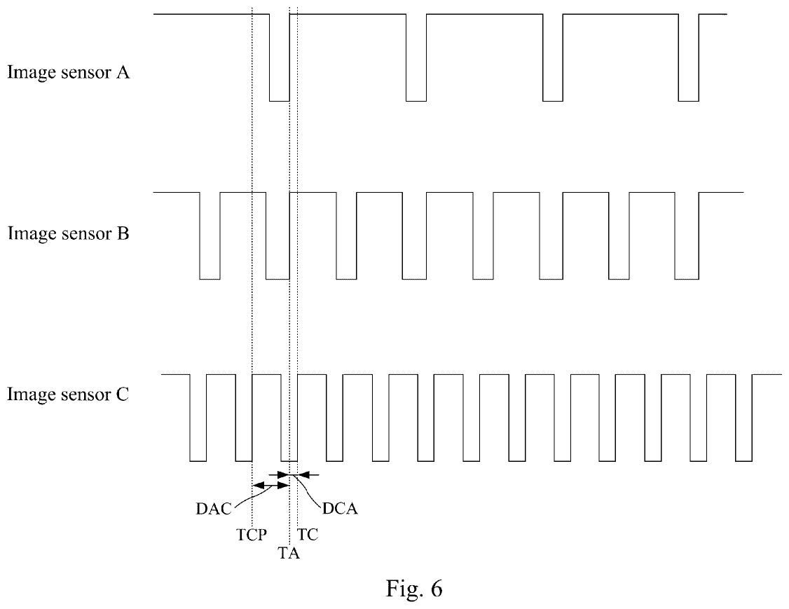

FIG. 6 shows an embodiment of frame rate of multiple image sensors of the present disclosure. In some embodiments, referring to FIG. 3, the synchronization method 200 of image sensors of the present disclosure utilizes the image sensor A as a reference point, and synchronizes the image sensor A and the image sensor B by adjusting the line length or the frame length of the image sensor B. The synchronization method of the image sensor C in FIG. 6 is similar to the synchronization method of the embodiment in FIG. 3, which will be explained in detail as shown below.

First of all, obtaining a second previous time of a second previous frame and a third current time of a third current frame of a third image sensor. For example, referring to FIG. 1 and FIG. 6, obtaining the previous time TCP of the previous frame and the current time TC of the current frame of the image sensor C.

In addition, calculating a third difference between the first current time and the third current time, and calculating a fourth difference between the first current time and the second previous time. Referring to FIG. 1 and FIG. 6, the processor 120 can be configured to calculate the difference DCA between the current time TA and the current time TC, and calculate the difference DAC between the current time TA and the previous time TCP.

Subsequently, adjusting a line length or a frame length of the third image sensor according to a second determination result of the third difference and the fourth difference to synchronize the first image sensor, the second image sensor, and the third image sensor. For example, referring to FIG. 1 and FIG. 6, the processor 120 can adjust the line length HTS or the frame length VTS of the image sensor C according to a determination result of the difference DCA and the difference DAC to synchronize the image sensor A, the image sensor B, and the image sensor C.

In some embodiments, if it is determined that the third difference is larger than the fourth difference, increasing the line length or the frame length of the third image sensor to synchronize the first image sensor, the second image sensor, and the third image sensor. For example, referring to FIG. 1 and FIG. 6, the processor 120 can determine a relation of the difference DCA and the difference DAC. If it is determined that the difference DCA is larger than the difference DAC, it represents that the frame rate of the image sensor C is faster relative to the frame rate of the image sensor A. The processor 120 increases the line length HTS or the frame length VTS of the image sensor C to decrease the frame rate of the image sensor C, so that the image sensor C can align frames with the image sensor A, thereby synchronizing the image sensor A, the image sensor B, and the image sensor C.

In some embodiments, if it is determined that the third difference is less than the fourth difference, decreasing the line length or the frame length of the third image sensor to synchronize the first image sensor, the second image sensor, and the third image sensor. For example, referring to FIG. 1 and FIG. 6, the processor 120 can determine a relation of the difference DCA and the difference DAC. If it is determined that the difference DCA is less than the difference DAC, it represents that the frame rate of the image sensor C is slower relative to the frame rate of the image sensor A. The processor 120 decreases the line length HTS or the frame length VTS of the image sensor C to increase the frame rate of the image sensor C, so that the image sensor C can align frames with the image sensor A, thereby synchronizing the image sensor A, the image sensor B, and the image sensor C.

In some embodiments, the synchronization methods 200, 500 of image sensors of the present disclosure can follow the above-mentioned embodiments to utilize any one of the image sensors as a reference image sensor for synchronizing the image sensors A˜N by adjusting the line length HTS or the frame length VTS of the remaining image sensors to align the remaining image sensors with the reference image sensor.

It is noted that the present disclosure is not limited to the embodiments as shown in FIG. 1 to FIG. 6, they are merely examples for illustrating the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The synchronization method of image sensors and the synchronization system of image sensors of the present disclosure can synchronize multiple image sensors by adjusting line length or frame length to ensure that multiple images can be correctly processed (e.g., image stitching), and the accuracy of Artificial Intelligence (AI) image recognition algorithms in processing multiple images can be guaranteed.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A synchronization method of image sensors, comprising:
obtaining a first current time of a first current frame of a first image sensor;
obtaining a first previous time of a first previous frame and a second current time of a second current frame of a second image sensor;
calculating a first difference between the first current time and the second current time;
calculating a second difference between the first current time and the first previous time; and
adjusting a first line length or a first frame length of the second image sensor according to a first determination result of the first difference and the second difference to synchronize the first image sensor and the second image sensor.

2. The synchronization method of claim 1, wherein calculating the first difference between the first current time and the second current time comprises:
subtracting the first current time from the second current time to obtain the first difference.

3. The synchronization method of claim 1, wherein calculating the second difference between the first current time and the first previous time comprises:
subtracting the first previous time from the first current time to obtain the second difference.

4. The synchronization method of claim 1, wherein adjusting the first line length or the first frame length of the second image sensor according to the first determination result of the first difference and the second difference to synchronize the first image sensor and the second image sensor comprises:
if it is determined that the first difference is larger than the second difference, increasing the first line length or the first frame length of the second image sensor to synchronize the first image sensor and the second image sensor.

5. The synchronization method of claim 1, wherein adjusting the first line length or the first frame length of the second image sensor according to the first determination result of the first difference and the second difference to synchronize the first image sensor and the second image sensor comprises:
if it is determined that the first difference is less than the second difference, decreasing the first line length or the first frame length of the second image sensor to synchronize the first image sensor and the second image sensor.

6. The synchronization method of claim 1, wherein a first frame rate of the first image sensor is a same as a second frame rate of the second image sensor.

7. The synchronization method of claim 1, wherein a first frame rate of the first image sensor is N times a second frame rate of the second image sensor, or the second frame rate of the second image sensor is N times the first frame rate of the first image sensor, wherein Nis an integer larger than 2.

8. The synchronization method of claim 1, wherein the first line length comprises a horizontal blanking, the first frame length comprises a vertical blanking, wherein adjusting the first line length or the first frame length of the second image sensor according to the first determination result of the first difference and the second difference to synchronize the first image sensor and the second image sensor comprises:
adjusting the first line length by adjusting the horizontal blanking of the second image sensor or adjusting the first frame length by adjusting the vertical blanking of the second image sensor to synchronize the first image sensor and the second image sensor.

9. The synchronization method of claim 1, further comprising:
obtaining a second previous time of a second previous frame and a third current time of a third current frame of a third image sensor;
calculating a third difference between the first current time and the third current time;
calculating a fourth difference between the first current time and the second previous time; and
adjusting a second line length or a second frame length of the third image sensor according to a second determination result of the third difference and the fourth difference to synchronize the first image sensor, the second image sensor, and the third image sensor.

10. The synchronization method of claim 9, wherein adjusting the second line length or the second frame length of the third image sensor according to the second determination result of the third difference and the fourth difference to synchronize the first image sensor, the second image sensor, and the third image sensor comprises:
if it is determined that the third difference is larger than the fourth difference, increasing the second line length or the second frame length of the third image sensor to synchronize the first image sensor, the second image sensor, and the third image sensor; and
if it is determined that the third difference is less than the fourth difference, decreasing the second line length or the second frame length of the third image sensor to synchronize the first image sensor, the second image sensor, and the third image sensor.

11. A synchronization system of image sensors, comprising:
a memory, configured to store a plurality of commands; and
a processor, configured to read the plurality of commands from the memory to execute following steps:
obtaining a first current time of a first current frame of a first image sensor;
obtaining a first previous time of a first previous frame and a second current time of a second current frame of a second image sensor;
calculating a first difference between the first current time and the second current time;
calculating a second difference between the first current time and the first previous time; and
adjusting a first line length or a first frame length of the second image sensor according to a first determination result of the first difference and the second difference to synchronize the first image sensor and the second image sensor.

12. The synchronization system of claim 11, wherein calculating the first difference between the first current time and the second current time which is executed by the processor comprises:
subtracting the first current time from the second current time to obtain the first difference.

13. The synchronization system of claim 11, wherein calculating the second difference between the first current time and the first previous time which is executed by the processor comprises:
subtracting the first previous time from the first current time to obtain the second difference.

14. The synchronization system of claim 11, wherein adjusting the first line length or the first frame length of the second image sensor according to the first determination result of the first difference and the second difference to synchronize the first image sensor and the second image sensor which is executed by the processor comprises:
if it is determined that the first difference is larger than the second difference, increasing the first line length or the first frame length of the second image sensor to synchronize the first image sensor and the second image sensor.

15. The synchronization system of claim 11, wherein adjusting the first line length or the first frame length of the second image sensor according to the first determination result of the first difference and the second difference to synchronize the first image sensor and the second image sensor which is executed by the processor comprises:
if it is determined that the first difference is less than the second difference, decreasing the first line length or the first frame length of the second image sensor to synchronize the first image sensor and the second image sensor.

16. The synchronization system of claim 11, wherein a first frame rate of the first image sensor is a same as a second frame rate of the second image sensor.

17. The synchronization system of claim 11, wherein a first frame rate of the first image sensor is N times a second frame rate of the second image sensor, or the second frame rate of the second image sensor is N times the first frame rate of the first image sensor, wherein Nis an integer larger than 2.

18. The synchronization system of claim 11, wherein the first line length comprises a horizontal blanking, and the first frame length comprises a vertical blanking, wherein adjusting the first line length or the first frame length of the second image sensor according to the first determination result of the first difference and the second difference to synchronize the first image sensor and the second image sensor which is executed by the processor comprises:
adjusting the first line length by adjusting the horizontal blanking of the second image sensor or adjusting the first frame length by adjusting the vertical blanking of the second image sensor to synchronize the first image sensor and the second image sensor.

19. The synchronization system of claim 11, wherein the processor is further configured to execute following steps:
obtaining a second previous time of a second previous frame and a third current time of a third current frame of a third image sensor;
calculating a third difference between the first current time and the third current time;
calculating a fourth difference between the first current time and the second previous time; and
adjusting a second line length or a second frame length of the third image sensor according to a second determination result of the third difference and the fourth difference to synchronize the first image sensor, the second image sensor, and the third image sensor.

20. The synchronization system of claim 19, wherein adjusting the second line length or the second frame length of the third image sensor according to the second determination result of the third difference and the fourth difference to synchronize the first image sensor, the second image sensor, and the third image sensor which is executed by the processor comprises:
if it is determined that the third difference is larger than the fourth difference, increasing the second line length or the second frame length of the third image sensor to synchronize the first image sensor, the second image sensor, and the third image sensor, and
if it is determined that the third difference is less than the fourth difference, decreasing the second line length or the second frame length of the third image sensor to synchronize the first image sensor, the second image sensor, and the third image sensor.
